(19) United States
(12) Patent Application Publication
(10) Pub. No.: US 2008/0129822 A1
(43) Pub. Date: Jun. 5, 2008

(54) OPTIMIZED VIDEO DATA TRANSFER

(76) Inventors: Glenn Daniel Clapp, Sandy, UT (US); Jeremy Noring, Corvallis, OR (US)

Correspondence Address: BAKER & ASSOCIATES PLLC, 470 EAST NINTH AVENUE, SALT LAKE CITY, UT, 84103, US

(21) Appl. No.: 11/873,365

(22) Filed: Oct. 16, 2007

Related U.S. Application Data
(60) Provisional application No. 60/864,632, filed on Nov. 7, 2006.

(51) Int. Cl. H04N 7/18

(52) U.S. Cl. 348/143

(57) ABSTRACT

The present invention relates to systems and methods for combining video data to optimize video performance for use with distributed multiple video monitoring systems. One embodiment of the present invention relates to a computer controlled surveillance system including distributed multiple real-time video display. The system includes a local data transmission system, a global data transmission system, a plurality of video capture devices, a control module, and a client module. The control module includes a combination module configured to generate a combined video data signal including a data combination of the plurality of video devices. The combined video data signal includes independently identifiable simultaneous representations of each of the video data signals packaged so as to posses a transmission bandwidth equal to approximately that of one of the video data signals. The client module is configured to display the combined video data signal.

### RELATED APPLICATIONS

This application claims priority to U.S. provisional application Ser. No. 60/864,632 filed Nov. 7, 2006, the contents of which are incorporated by reference.

### FIELD OF THE INVENTION

The invention generally relates to systems and methods for optimized video data transfer. In particular, the invention relates to systems and methods for combining video data for optimized video performance in a distributed multiple video monitoring system.

### BACKGROUND OF THE INVENTION

Video monitoring systems are used to monitor video signals from one or more discrete locations or view angles. These systems are often used for security, surveillance, and personnel performance monitoring. Video monitoring systems generally include video capture devices, a control device, and a display. The video capture devices are a group of cameras configured to record video data at particular discrete locations. The control device is a computer or electronic module that receives the video data from each of the video capture devices and routes the signal to the display. The display converts the video data into a visually identifiable format. These components may be embedded into a personal computer, distributed across a digital computer network, or may incorporate portions of a computer network for purposes of data transmission and/or display.

Users of a multi-location video monitoring system may wish to display the video data from a remote location that is not necessarily within the scope of the local data transmission system that is used to transfer video data from the video capture devices to the control device. Therefore, the control device may also be coupled to a wide area network (WAN) or global network for purposes of remote data viewing. For example, a user may wish to view video data on a remote computer or handheld video display device that is data coupled to the Internet. However, one of the problems associated with conventional remote viewing of multi-location video data is the large transmission bandwidth required to transmit the independent video data signals that are associated with video monitoring systems. For example, a system that includes video data devices at four discrete locations produces a large bandwidth of video data which is unable to be reliably transmitted to a single device across many global data transmission systems. Furthermore, it is impractical and undesirable to require users to display the video data from each of discrete video inputs individually or on independent display devices. Alternately, in order to provide multiple video streams over limited bandwidth, quality is sacrificed by any combination of reducing frame rate, increasing compression, and reducing video size. In many cases, video is simulated by transferring still images periodically rather than actual video.

Therefore, there is a need in the video data monitoring industry for a system that allows for the reliable and efficient data transmission of multi-location video data across common global data transmission systems.

### SUMMARY OF THE INVENTION

The present invention relates to systems and methods for combining video data to optimize video performance for use with distributed multiple video monitoring systems. One embodiment of the present invention relates to a computer controlled surveillance system including distributed multiple real-time video display. The system includes a local data transmission system, a global data transmission system, a plurality of video capture devices, a control module, and a client module. The local and global data transmission systems may include overlapping or distinct hardware, software, firmware, etc. For example, the local data transmission system may be a local power line network and the global data transmission system may be the Internet. The video devices are configured to capture and independently transmit substantially real-time video data signals to the control module across the local data transmission system. The control module includes a combination module configured to generate a combined video data signal including a data combination of the plurality of video capture devices. The combined video data signal includes independently identifiable simultaneous representations of each of the video data signals packaged so as to posses a transmission bandwidth equal to approximately that of one of the video data signals. The control module is coupled to the client module via the global data transmission system. The client module is configured to display the combined video data signal including the independent identifiable representations of each of the video data signals. A second embodiment of the present invention relates to a method for minimizing transmission bandwidth of a plurality of video data signals within a distributed video surveillance system.

Another impediment associated with conventional remote viewing multiple video data systems is the necessary traversal of Network Address Translation devices (“NAT” devices). NAT devices allow the configuration of private sub-networks that are isolated from global networks and the capability to implement local security measures. However, network security often impedes video transmission in that each individual video stream must be configured to be accessible through local NAT devices. Therefore conventional multi-location video data systems must authenticate the video data signal from each of the individual video data signals. Embodiments of the present invention utilize a combined or consolidated video data signal and thereby minimize the above-mentioned issues with NAT circumvention because only a single video signal needs to be authenticated.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular—rather than complete—portions of the systems and methods of making and using the system according to the invention. In the Figures, the physical dimensions may be exaggerated for clarity.

FIG. 1 illustrates a flow chart of a suitable computer operating environment for embodiments of the present invention;

FIG. 2 illustrates a schematic view of a computer controlled distributed multiple video monitoring system which may be used in conjunction with embodiments of the present invention;

FIG. 3 illustrates a schematic view of a computer controlled surveillance system including distributed multiple real-time remote viewing video display in accordance with one embodiment of the present invention; and

FIG. 4 illustrates a flow chart of a method for minimizing transmission bandwidth of a plurality of real-time video data signals within a distributed video surveillance system in accordance with a second embodiment of the present invention.

### DETAILED DESCRIPTION OF THE INVENTION

The present invention relates to systems and methods for combining video data to optimize video performance for use with distributed multiple video monitoring systems. One embodiment of the present invention relates to a computer controlled surveillance system including distributed multiple real-time video display. The system includes a local data transmission system, a global data transmission system, a plurality of video capture devices, a control module, and a client module. The local and global data transmission systems may include overlapping or distinct hardware, software, firmware, etc. For example, the local data transmission system may be a local power line network and the global data transmission system may be the Internet. The video devices are configured to capture and independently transmit substantially real-time video data signals to the control module across the local data transmission system. The control module includes a combination module configured to generate a combined video data signal including a data combination of the plurality of video capture devices. The combined video data signal includes independently identifiable simultaneous representations of each of the video data signals packaged so as to posses a transmission bandwidth equal to approximately that of one of the video data signals. The control module is coupled to the client module via the global data transmission system. The client module is configured to display the combined video data signal including the independent identifiable representations of each of the video data signals. A second embodiment of the present invention relates to a method for minimizing transmission bandwidth of a plurality of video data signals within a distributed video surveillance system. While embodiments of present invention are described in reference to a distributed multiple video monitoring system, it will be appreciated that the teachings of present invention are applicable to other areas.

The following terms are defined as follows:

Video surveillance system—a system for location based video monitoring for purposes including surveillance, monitoring, and/or personnel performance.

Local data transmission system—a data transmission system for transferring data between components within a confined region. For example, a local Ethernet, power line computer network, wireless network, or analog or digital wired or wireless transmission systems.

Global data transmission system—a data transmission system for transferring data between distributed components within a geographically large area. For example, the Internet enables data transmission between distributed components. A global data transmission system is defined broadly to include a local data transmission system.

Control module—a computer and/or electrical component in a video system for purposes including receiving, transmitting, displaying multi-location video data, compositing video from multiple sources, and/or reencoding into a single video stream.

Client module—a computer and/or electrical component that is configured to enable a user to view video data.

Video data signal—a stream of graphical video data capturing time based sequential images of a particular location. A real-time video data signal or stream includes video data of the location at substantially current time.

Video capture device—a device configured to capture and generate a video data signal. A video data signal may be produced by either an analog or digital video capture device.

Multi-use personal computer—a computing device that is used for a multitude of purposes including that which is specified. For example, a personal computer is routinely used to perform numerous distinct tasks including personal Internet browsing, accounting, and the like.

Mathematical algorithm—a mathematical process that may further include numerically identifying, correlating, calculating, converting, compressing, etc. For example, a data signal or data set may be manipulated by a mathematical algorithm to effect the size and display characteristics.

Transmission bandwidth—the necessary bandwidth to transmit a particular data signal. Transmission bandwidth corresponds to efficiency and rate of data transfer depending on the particular characteristics of the data coupling.

Visual tiling—visually positioning multiple images and/or video data so as to be simultaneously visually distinguishable. For example four square visual tiling would include positioning up to four images and/or video signals in a four square quadrant format such that each of the four images and/or video occupy a distinct quadrant of the display.

The following disclosure of the present invention is grouped into two subheadings, namely “Operating Environment” and “Multi-Location Remote Video System”. The utilization of the subheadings is for convenience of the reader only and is not to be construed as limiting in any sense.

### Operating Environment

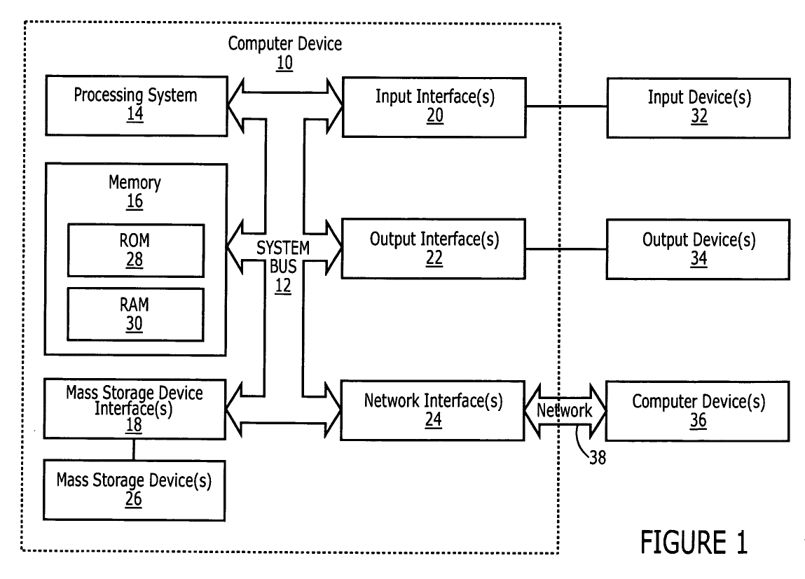

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”), smart phone, or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Multi-Location Remote Video System

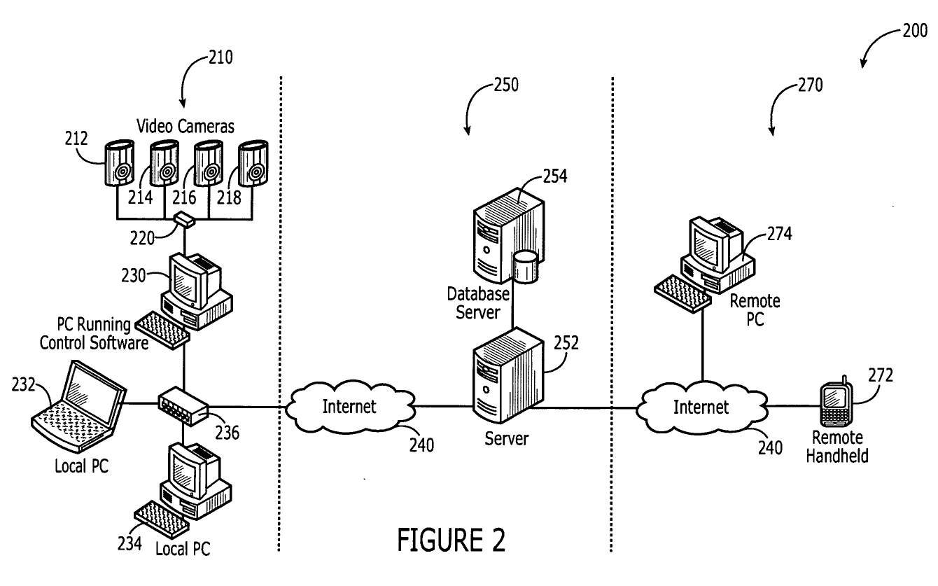

Reference is next made to FIG. 2, which illustrates a schematic view of a computer controlled distributed multiple video monitoring system, designated generally at 200. The illustrated system 200 architecture is an example of one type of video monitoring system in which embodiments of the present invention may be utilized. Various components of the illustrated system will be further described for purposes of reference to the embodiments of the present invention. It will be appreciated that embodiments of the present invention may be utilized with other alternative distributed video monitoring system architectures. The illustrated system 200 includes a local computer controlled video monitoring/surveillance system 210, a distributed data processing system 250, and a remote client system 270. The systems 210, 250, 270 are coupled via the Internet 240 acting as a global data transmission system. As is well known in the industry, various components may be further distributed or geographically consolidated for purposes of utilizing hardware and/or data coupling resources.

The computer controlled video monitoring system 210 includes a plurality of video capture devices 212, 214, 216, 218, a video router 220, a control module 230, a local laptop client 232, a local pc client 234, and a local network router 236. The video capture devices 212, 214, 216, 218 are digital video cameras configured to capture video data of a particular location and generate a video data signal that includes graphical sequential images of the particular location. One type of digital video capture device is a WILFE® brand camera. The video capture devices 212, 214, 216, 218 are data coupled to the control module 230 via a video router 220. The video router 220 is an optional component and may be any type of data converter, multiplexer, or router such as a USB power line data converter or Ethernet data converter. For example, the video capture devices 212, 214, 216, 218 may be coupled to a power line network such as a HOMEPLUG type system in which a USB data converter allows the control module 230 to receive the video data signal from all of the video capture devices 212, 214, 216, 218 across the power line. The video capture devices 212, 214, 216, 218 may include a variety of different types of devices including but not limited to analog, digital, wireless, wired, panable, fixed, indoor, outdoor, discrete, spy, mobile, etc. The control module 230 is a multi-use personal computer running a software module configured to receive and process the video data signals from the video capture devices 212, 214, 216, 218. For example, the software module may be a WILIFE® brand program. The control module 230 may perform other tasks in addition to managing the video data signals utilizing a well known multiprocessing operating system such as Microsoft WINDOWS®. The control module 230 may be configured to record, display, alert, or transmit data corresponding to the video data signals from the video capture devices 212, 214, 216, 218. The local laptop client 232 and local pc client 234 are data coupled to control module 230 via an optional network router 236 such as an Ethernet wired router or wireless 802.11 type data router. Various other local network architectures may be utilized to distribute the video data signals among the local clients 232, 234 and between the video capture devices 212, 214, 216, 218, and the control module 230.

The computer controlled video monitoring system 210 is coupled to the distributed data processing system 250 via the Internet 240. The distributed data processing system 250 includes a database server 254 and a server 252. The database server 254 may be configured to store video data from one or more computer controlled video monitoring systems 210, authentication information, account information, etc. The server 252 may be used to facilitate routing video data from the computer controlled video monitoring system 210 to the remote client system 270. For example, the illustrated server 252 and database server 254 may authenticate a user on the remote client system 270 and transmit the appropriate one or more requested video data signals from the corresponding computer controlled video monitoring system 210. Various other management and storage type functions may be performed by the distributed data processing system 250. In an alternative data processing configuration, data signals from the computer controlled video monitoring system 210 may be routed directly to the remote client system 270 without the data processing system 250. Depending on various communication parameters, the use of intermediary data routing, authentication, and/or processing through the distributed data processing system 250 is optional.

The remote client system 270 includes a remote client pc 274 and a remote client handheld 272, both data coupled to the Internet 240. The remote clients 272, 274 may display one or more video data signals from the video capture devices 212, 214, 216, 218 of the computer controlled video monitoring system 210. In particular, the remote clients 272, 274 may select to view the multiple video data signals individually, simultaneously, or intermittently. The remote clients 272, 274 may also interface with the distributed data processing system 250 for purposes of authentication, data routing, electronic payment, management, etc. The remote clients 272, 274 may be coupled to the Internet 240 utilizing various well known connection schemes including but not limited to cellular phone data networks, local computing data networks, etc. The remote clients 272, 274 may interface and/or receive the video data signals from a web browser or directly within a particular local software module. Likewise, the remote clients 272, 274 may receive email attachments corresponding to data from the computer controlled video monitoring system 210.

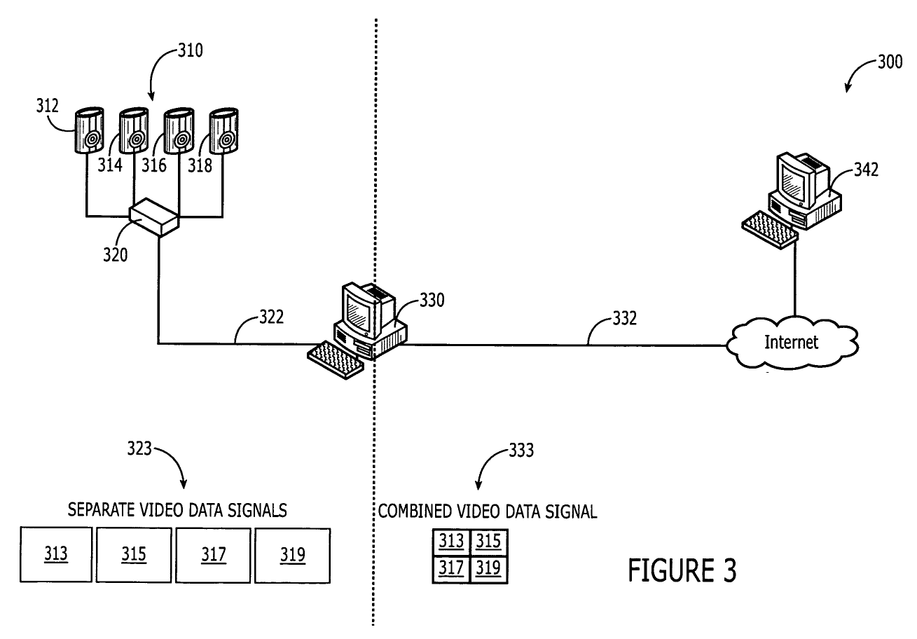

Reference is next made to FIG. 3, which illustrates a schematic view of a computer controlled surveillance system designated generally at 300. The system 300 includes a plurality of video capture devices 310 individually including a first device 312, second device 314, third device 316, and a fourth device 318. The video capture devices 310 generate corresponding separate video data signals 323 transmitted to a control module 330 via a local data transmission system 322. The video capture devices 310 and control module 330 are also coupled via the local data transmission system 322 to an optional video data router or data converter 320. As described above, various local data transmission mediums and data conversion/routing schemes may be used to transmit the video data signals from the video capture devices 310 to the control module 330 including but not limited to Ethernet, power line, Wi-Fi, cellular, etc. The separate video data signals 323 include individual video data signals corresponding to each of the video capture devices. The first video capture device 312 generates a video data signal 313, the second video capture device 314 generates a video data signal 315, the third video capture device 316 generates a video data signal 317, and the fourth video capture device 318 generates a video data signal 319. It will be appreciated that any number of video capture devices and corresponding video data signals may be utilized in conjunction with teachings of the present invention. The separate video data signals 323 may be transmitted to the control module 330 via well known data packaging techniques including serial, parallel, compression, etc but remain separate data signals having individually quantifiable transmission bandwidths. Therefore, the transmission bandwidth necessary for transmitting the separate video data signals 323 in their entirety is related to the number of video capture devices producing the video data signals. However, the transmission bandwidth of each of the video data signals 323 depends in large part on the particular content and video recording parameters for the corresponding video capture device. The transmission bandwidth of a particular video data signal corresponds to the necessary bandwidth for transmitting the video data signal from one device to another. The generated separate video data signals 323 may also be referred to as real-time video data signals in that they correspond to substantially updated or present video data representations of particular locations. The local data transmission system 322 may be particularly suited for high speed transmission of large data signals thereby facilitating the transmission of the separate video data signals 323 at an efficient rate while preserving substantially real-time video data.

The control module 330 is a computer device data coupled to both the local data transmission system 322 and the global data transmission system 332. The global data transmission system 332 may include the Internet. It should be noted that the local and global data transmission systems may include overlapping scope, hardware, software, or firmware. The control module 330 includes a combination module for combining the separate video data signals 323 from each of the video capture devices 310 into a combined video data signal 333. The combined video data signal 333 is packaged so as to require a transfer bandwidth substantially equal to that of a single video data signal from a single one of the video capture devices 310. The combined video data signal 333 includes independently identifiable simultaneous representations of each of the individual video data signals 313, 315, 317, 319. Various well known mathematical and visual-based algorithms for combining and compressing video data signals may be used including visually tiling the video data signals. One particular example of visual tiling is four square tiling represented by the illustration of the combined video data signal 333 and the corresponding individual video data signal 313, 315, 317, 319 components. The individual data signals 313, 315, 317, 319 are compressed and visually positioned within individual quadrants such that they are simultaneously viewable representations. It will be appreciated that other forms of visual tiling may be applied to accommodate alternative numbers of simultaneous multi-video representations. The control module is further configured to transmit the combined video data signal to one or more client modules 342 via the global data transmission system 332. The transmission of the combined video data signal 333 may be in response to a particular triggering event such as a request from the client module 342.

The client module 342 receives the combined video data signal 333 via the global data transmission system 332. The client module 342 is a remotely located computer and/or electronic device such as a personal computer, handheld device, cell phone, PDA, tablet, television, etc. Since the combined video data signal 333 is sized with a reasonable transmission bandwidth, it is possible to reliably receive the video data signals and corresponding visual display information from the multiple video devices without substantial delay or errors otherwise due to large transmission bandwidth requirements. Therefore, embodiments of the present invention enable multi-video remote viewing over lower bandwidth global data networks such as cell phone data networks and the like.

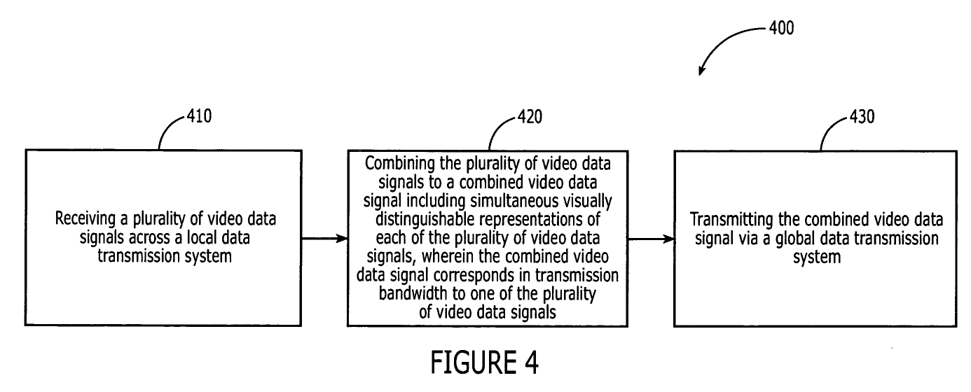

Reference is next made to FIG. 4, which illustrates a flow chart of a method for minimizing transmission bandwidth of a plurality of real-time video data signals within a distributed video surveillance system, designated generally at 400. The illustrated and described method may be performed by a computing device such as a video monitoring system control module. The method includes receiving a plurality of video data signals across a local data transmission system, act 410. The received video data signals may includes various non-video data such as identification, location, time, motion detection, etc. The plurality of video data signals are combined into a combined video data signal including simultaneous visually distinguishable representations of each of the plurality of video data signals, wherein the combined video data signal corresponds in transmission bandwidth to one of the plurality of video data signals, act 420. The act of combining may further include the application of a mathematical algorithm to compress and/or visually configure the video data signals. The combined video data signal is transmitted via a global data transmission system, act 430. The transmission may be continuous so to provide an updated and/or real-time video signal to a client device.

Various other embodiments have been contemplated including combinations in whole or in part of the embodiments described above.

What is claimed is:

1. A computer controlled surveillance system including distributed multiple real-time video display comprising:
a local data transmission system;
a global data transmission system;
a plurality of video input sources, wherein each video input source includes a video capture device configured to create a corresponding real-time video data signal, and wherein the plurality of video input sources are coupled to the local data transmission system;
a control module coupled to the plurality of video input sources via the local data transmission system, wherein the coupling includes the plurality of real-time video data signals, and wherein the control module further includes a combination module configured to combine the plurality of real-time video data signals into a combined video data signal, and wherein the combined video data signal includes a data combination of the plurality of real-time video data signals such that a display of the combined video data signal includes independently identifiable simultaneous representations of each of the plurality of real time video data signals, and wherein the control module includes a coupling to the global data transmission system including the combined video data signal; and
a client module coupled to the global data transmission system including a display of the combined video data signal.

2. The system of claim 1, wherein the transmission bandwidth of the combined video data signal is approximately equal to the transmission bandwidth of one of the real-time video data signals.

3. The system of claim 1, wherein at least one of the video capture devices is a digital video capture device.

4. The system of claim 1, wherein the local data transmission system is an independent data transmission medium from the global data transmission system.

5. The system of claim 1, wherein the control module is a software module disposed on a multi-use personal computer.

6. The system of claim 1, wherein the global data transmission system is the Internet.

7. The system of claim 1, wherein the combination module comprises a mathematical algorithm configured to mathematically combine the plurality of real-time video data signals into a combined video data signal including simultaneous visually distinguishable complete representations of each of the real-time video data signals.

8. The system of claim 7, wherein the simultaneous visually distinguishable complete representations include a visual tiling of each of the real-time video data signals.

9. The system of claim 8, wherein the visual tiling includes four square tiling.

10. The system of claim 1, wherein the combination module includes an algorithm configured to identify the number of real-time video data signals and an algorithm configured to combine the plurality of real-time video data signals according to the number of identified real-time video data signals.

11. A method for minimizing transmission bandwidth of a plurality of real-time video data signals within a distributed video surveillance system including the acts of:
receiving a plurality of independently generated video data signals from a local data transmission system;
combining the plurality of real-time video data signals to a combined video data signal including simultaneous visually distinguishable representations of each of the plurality of real-time video data signals in the combined video data signal, wherein the combined video data signal corresponds in transmission bandwidth to one of the plurality of independently generated real-time video data signals; and
transmitting the combined video data signal via a global data transmission system.

12. The method of claim 11, wherein the act of combining the plurality of real-time video data signals to a combined video data signal includes identifying the number of independently generated real-time video data signals and combining the real-time video data signals according to the identified number.

13. The method of claim 11, wherein the act of receiving a plurality of independently generated real-time video data signals from a local data transmission system includes receiving a local network data signal.

14. The method of claim 11, wherein the act of combining the plurality of real-time video data signals to a combined video data includes visually tiling the real-time video data signals.

15. The method of claim 14, wherein visually tiling the real-time video data signals includes resizing and positioning a visual representation of each of the real-time video data signals so as to enable all of the real-time video data signals to be simultaneously displayed.

16. The method of claim 11, wherein the act of combining the plurality of real-time video data signals to a combined video data includes four square visually tiling the real-time video data signals.

17. The method of claim 16, wherein four square visually tiling the real-time video data signals includes resizing and positioning a visual representation of four of the real-time video data signals so as to enable all of the real-time video data signals to be simultaneously displayed in a quadrant format.

18. A method for minimizing transmission bandwidth of a plurality of video data signals within a distributed video surveillance system including the acts of:
receiving a plurality of independently generated video data signals from a local data transmission system;
combining the plurality of video data signals to a combined video data signal including incorporating simultaneous tiled visually distinguishable representations of each of the plurality of video data signals in the combined video data signal, wherein the combined video data signal corresponds in transmission bandwidth to one of the plurality of independently generated video data signals;
wherein combining the plurality of video data signals to a combined video data signal includes identifying the number of independently generated video data signals and correspondingly adjusting the size of the simultaneous tiled visually distinguishable representations of each of the plurality of video data signals according to the identified number of independently generated video data signals; and
transmitting the combined video data signal via a global data transmission system.

19. The method of claim 18, wherein the act of receiving the plurality of independently generated video data signals includes decoding the plurality of independently generated video data signals into a visually representable format.

20. The method of claim 18, wherein the act of transmitting the combined video data signal includes compressing the combined video data signal according to an optimum data compression format corresponding to the global data transmission system.
